(19) United States
(12) Patent Application Publication
(10) Pub. No.: US 2026/0044864 A1
(43) Pub. Date: Feb. 12, 2026

(54) Customer Retention System with Integrated AI Agent

(71) Applicant: LiveX AI Incorporated, Palo Alto, CA (US)

(72) Inventors: Yujia Li, Palo Alto, CA (US); Jia Li, Palo Alto, CA (US); Yao Zhao, Fremont, CA (US)

(21) Appl. No.: 19/074,317

(22) Filed: Mar. 8, 2025

Related U.S. Application Data
(60) Provisional application No. 63/681,145, filed on Aug. 9, 2024.

(51) Int. Cl. G06Q 30/016; G06Q 30/0207

(52) U.S. Cl. CPC G06Q 30/016; G06Q 30/0224

(57) ABSTRACT

Systems and methods for retaining users of a subscribed service are disclosed. A user interface is installed in a terminal device, and is used to interact with end user, receive prompt from and display information to end user. An artificial intelligence agent is trained to communicate with end users in natural language or video streaming about cancellation of the subscribed service via the user interface. The artificial intelligence agent is trained with end user specific information, such as subscription, prior usage of the subscribed service. Such communication may further lead to human-to-human interaction between end users with customer support, service providers, etc.

### TECHNICAL FIELD

The embodiments provided herein a system and a method to interact with an end user of a subscribed service for customer retention purpose, and more particularly, a method utilizing artificial intelligence (AI) agent to provide interactive communication in natural language with an end user in relation to a cancellation of a subscribed service.

### BACKGROUND

Subscription cancellation is a critical moment to collect end user feedback and to retain customers for subscription-based services, especially for software companies conducting a business based on Software as a Service (SaaS) subscription model.

Traditional direct cancellation method can provide a baseline function to cancel the subscribed service. Although this method fulfills customers' need to cancel services and is compliant with relevant regulatory and compliance requirements, it is a missed opportunity from a business point of view. Because end users can cancel the subscribed service without any feedback interaction, with machine or with human being, the service provider has no chance to understand the reason of cancellation, or to address end users' concerns. In the long run, it is difficult for service providers to gather valuable information, such as feedback for service improvements.

Some existing cancellation systems or methods involve pop-up forms or promotions. This method uses pop-up forms to communicate with end users and offer promotions, which may comprise some service specific options. It provides interaction to collect feedback from customers to a certain level. While this pop-up method can be effective in capturing attention and delivering messages quickly, it comes with several significant drawbacks. One major limitation is the potential for user frustration; pop-ups are often perceived as intrusive and can disrupt the user's cancellation procedure, potentially leading to more negative feelings towards the service. Another disadvantage is the risk of ineffectiveness, as the promotions or information presented in pop-ups may not always be relevant or appealing to the user, resulting in wasted effort and potentially ignored messages. Furthermore, pop-ups often lack personalization, missing out on the opportunity to engage users with tailored content that could be more effective in driving desired actions.

Follow-up email is another method adopted by service providers to re-engage users who have already canceled their subscription of service. While this approach can provide an opportunity to address any concerns and potentially win back customers, it has notable limitations. One significant disadvantage is its general ineffectiveness; once a user has decided to cancel, follow-up emails often fail to change their decision. The effort to re-engage a user post-cancellation can come across as too little, too late, and may not address the underlying reasons for their departure. Additionally, these emails can be perceived as bothersome or desperate, further alienating consumers. While follow-up emails offer a chance to gather feedback and possibly rectify issues, their overall success rate in retaining customers post-cancellation is typically low, suggesting that more proactive engagement strategies might be necessary to prevent churn in the first place.

Some subscription cancellations introduce human interaction into the process. Human agent escalation involves redirecting users who are attempting to cancel their subscription to a live customer service representative. This method can be beneficial as it allows for personalized interaction, giving the service provider a chance to address specific concerns and potentially persuade the end user to stay. However, it comes with significant limitations. One major disadvantage is regulatory compliance; the Federal Trade Commission mandates that companies provide an easy online cancellation process, and requiring interaction with a human agent can violate this requirement. Additionally, this approach can lead to user frustration, as many customers find it cumbersome and time-consuming to speak with a representative when they simply want to cancel their service. This frustration can further damage the customer relationship and deter users from considering the service again in the future. Furthermore, from a business point of view, engaging human agent escalation normally implies more human resources, especially when a team of human agent is needed to stand by no matter they may be connected to an end user or not. This is resource intensive and not scalable like other existing methods.

None of the existing solutions stated above offer on the spot problem solving with seamless experience of service termination while improving the customer retention rate at the critical moment of termination. Therefore, to achieve a higher level of a customer's feedback about his/her user experience of a subscribed service, and possible reduce the voluntary churn, there is a need to provide a more effective, empathetic, and personalized cancellation experience for end users.

### SUMMARY

Generally provided are a system and method for customer retention. The system aims to address the common reasons users cancel their subscriptions and to offer a seamless, respectful, and informative process that can potentially retain users or at least gather valuable feedback for future improvements of a subscribed service.

An artificial intelligence (AI) agent is used in a user retention system. Such AI agent is pre-trained using one or more databases with various kinds of information. Incorporation of the AI agent significantly improves the user experience during the cancellation process through empathetic, personalized interactions and ease of use. The AI agent, trained by company-specific knowledge, responds with sympathy and understanding, making users feel valued even as they cancel. The streamlined, transparent process contributes to overall user satisfaction.

The system is purported to improve customer retention rate by offering tailored retention offers based on user profiles and behavior, increasing the chances of retaining customers. The system is also configured to automatically identify and resolve technical issues in real-time, potentially addressing the root causes of cancellation requests.

The system is configured to communicate with end users via a user interface of a terminal device. Using natural language, video streaming, or other natural way of interacting with human being, the AI agent is configured to gather detailed feedback on why users are choosing to cancel, providing valuable insights that can inform product or service improvements. The system is also configured to ask for feedback in a non-intrusive manner, ensuring that users do not feel pressured or frustrated.

In some embodiments, the system is further configured to provide responses based on information about the company's cancellation policy, remaining billing cycles, refunds, and data retention, ensuring transparency and compliance with regulations. In some embodiments, the system is further configured to respond to end users' request to escalate to a human agent. This configuration ensures those with unresolved issues can get the help they need without making it a mandatory step. In some embodiments, the system is further configured to provide information on how end users can reactivate their subscriptions in the future, along with any changes or improvements to the service. This configuration keeps the door open to departing customers for future business.

In accordance with an embodiment, a method to train the AI agent is proposed. The AI agent adopts Large Language Model (LLM) machine learning algorithm as a part of the training. This way, the system is enabled to handle cancellations in a respectful and empathetic manner. The tone of communication helps maintain a positive brand reputation, even among users who decide to leave.

In accordance with another embodiment, information of an Application Programming Interface (API) is input to the AI agent. Such API could be a software program of the service provider itself. Such API could also be a software program of a third-party software developer. Moreover, some static information or data is input to form the baseline of the model. Such static information comprises static business knowledge of a service, a workflow of subscription cancellation, domain knowledge about the industry of which the service belongs to, and language tone which is suitable for provision of customer service. The method to train the AI agent can be applied whenever necessary to keep the static information up to date.

In accordance with some embodiments, a method for end users to interact with a subscription cancellation system is provided. The method includes the steps of collecting end user specific information by an AI agent, receiving a prompt from an end user about terminating subscription of a service, generating response by the AI agent to the prompt based on the end user specific information, and delivering the response to the end user via a user interface of a terminal device.

This summary is provided to efficiently present the general concept of the invention and should not be interpreted as limiting the scope of the claims.

### BRIEF DESCRIPTION OF THE DRAWINGS

For the purpose of facilitating understanding of the embodiments, the accompanying drawings and description illustrate embodiments thereof, its various structures, construction, method of operation, and many advantages that may be understood and appreciated. According to common practice, the various features of the drawings are not drawn to scale. On the contrary, the dimensions of the various features are arbitrarily expanded or reduced for clarity.

FIG. 1 is a diagram of the architecture of the customer retention system for subscribed service with integrated AI agent in accordance with aspects of the invention.

FIG. 2 is a workflow of using AI agent of the customer retention system to handle user's request to cancel subscription service, and take actions in accordance with aspects of the invention to improve customer retention rate with enhanced user experience.

FIG. 2A is an exemplary diagram of a communication the system output to an end user in accordance with aspects of the invention to improve customer retention rate with enhanced user experience.

### DETAILED DESCRIPTION

Many alternative embodiments of the present aspects may be appropriate and are contemplated, including as described in these detailed embodiments, though also including alternatives that may not be expressly shown or described herein but as obvious variants or obviously contemplated according to one of ordinary skill based on reviewing the totality of this disclosure in combination with other available information. For example, it is contemplated that features shown and described with respect to one or more embodiments may also be included in combination with another embodiment even though not expressly shown and described in that specific combination.

For purpose of efficiency, reference numbers may be repeated between figures where they are intended to represent similar features between otherwise varied embodiments, though those features may also incorporate certain differences between embodiments if and to the extent specified as such or otherwise apparent to one of ordinary skill, such as differences clearly shown between them in the respective figures.

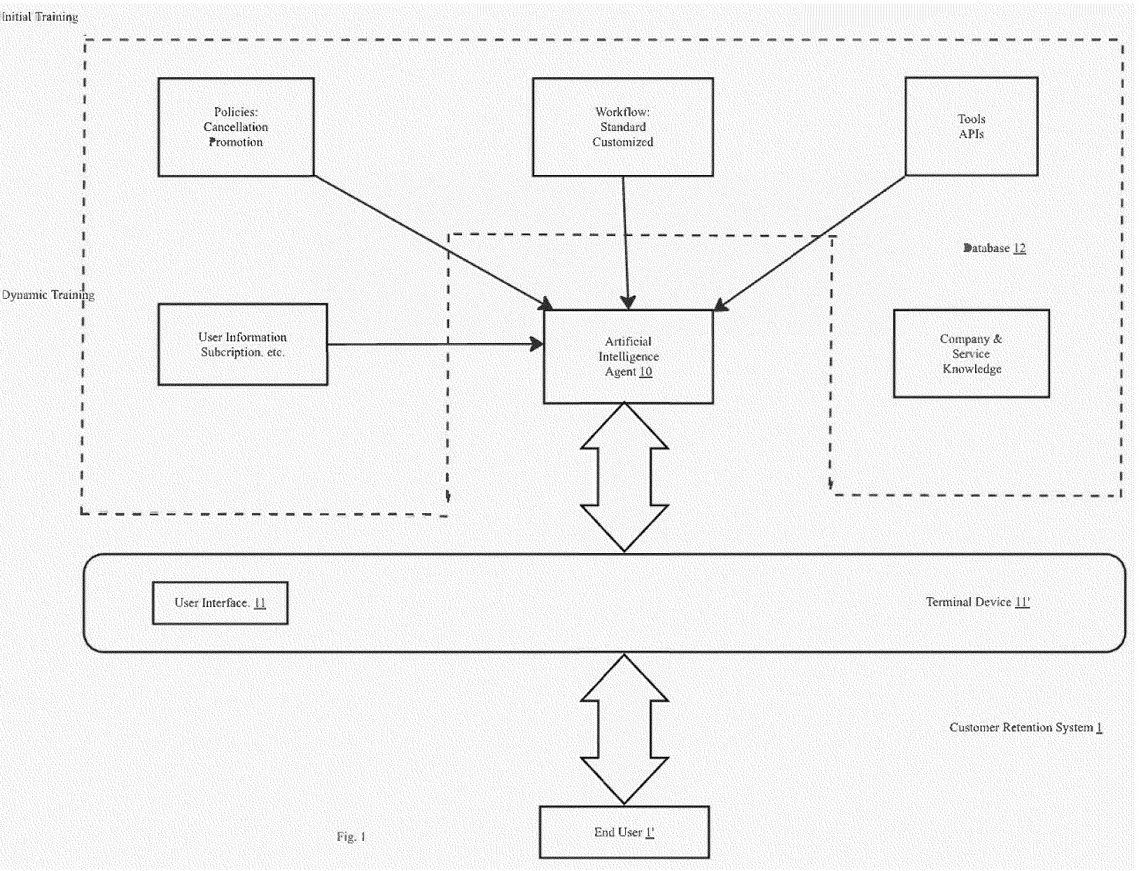

Reference is now made to FIG. 1, which is diagram illustrating an architecture of the customer retention system for subscribed service with integrated AI agent, in accordance with aspects of the invention and consistent with embodiments of the present disclosure.

Customer Retention System 1 with integrated AI agent depicts an AI Agent 10, a User Interface 11, a Training Database 12. The system interacts and communicates with an End User 1′ via a Terminal Device 11′ where the User Interface 11 is installed in.

Customer Retention System 1 is purported to provide End User 1′ of a subscription service an interactive, personalized, empathetic, and automated user experience of cancellation of the subscribed service.

AI Agent 10 is a software program based on machine learning algorithms such as LLM to receive and understand natural languages, process information based on trained algorithms, and provide output as responses to end users in a natural way human understand. LLM is an artificial intelligence algorithm specializing in its general-purpose language generation capabilities. The model acquires abilities through learning statistical relationships from text documents in the training process. The model is generally trained through massive data sets to comprehend and generate human language text. Due to the model's specialty in processing, comprehending, and corresponding in natural languages of human beings, the model is specifically fit for the industry and business of customer services which require understanding, communication, and interaction with human beings in their human languages. LLM serves as a solid starting point to train AI Agent 10. However, there are also challenges associated with LLMs such as bias, hallucination, and complexity that lead to inaccurate or misleading responses. Hence, there is always a desire to further improve or identify better artificial intelligence algorithms for the proposed application and disclosure here. And any other suitable types of artificial intelligence algorithms in accordance with aspects of the invention will be understood by one of skill in the same art. In any case, AI Agent 10 is designed to work seamlessly with User Interface 11 and other parts of Customer Retention System 1, including Database 12.

In some embodiments, the AI agent is a remote web-based or cloud-based solution. AI Agent 10 is remotely stored in a server that provides cloud service. AI Agent 10 is located separately from End User 1′. End User 1′ interacts with User Interface 11 through Terminal Device 11′ which is electronically or magnetically connected to AI Agent 10. Terminal Device 11′ is configured to be in close proximity of End User 1′ to provide instant interaction with End User 1′.

In some other embodiments, AI Agent 10 is an edge AI solution, meaning, AI Agent 10 is stored in an edge computing environment. In some embodiments, such edge computing environment may be separate from Terminal Device 11′ but can next to Terminal Device 11′ and coupled with Terminal Device 11′ electrically or magnetically. In some other embodiments, such edge computing environment can be Terminal Device 11′ itself. Similarly, AI Agent 10 is a part embedded in Terminal Device 11′ and coupled with other parts of Terminal Device 11′ electrically or magnetically.

Database 12 is the data repository used by Customer Retention System 1 to store all kinds of training data which are used to train AI Agent 10. The number of databases can be more than one. AI Agent 10 is configured to acquire information from these bases, namely, policy database, workflow database, tool or API database, user information database, service information database, and more. But by and large, there are two categories of databases. The initial database is the type of database that stores data to be used in initial training sessions of AI Agent 10. The dynamic database is the type of database that stores data to be visited more often and used in dynamic training sessions of AI Agent 10. With training by the data from these databases, a bare bone LLM model which can only understand general human languages, is cultivated to a special-task-oriented AI agent—to handle customers' request of cancelling subscription service and to improve customer retention rate from cancellation.

Data stored in the initial training database are less frequently updated or visited. They are almost constant and require minimum frequency of updating. In some embodiments, these data are accessed at the initial training session. Data stored in the initial database are more static and less changed information. Static data are used at the initial training and then the trained model or algorithm of AI Agent 10 is deployed. Because this type of information is seldom changed and desired to be kept the same for continuity reason, it forms the fundamental training database of the Customer Retention System 1. AI Agent 10 is trained by such static information and configured to provide responses to cancellation request based off such information. However, although static, it is not that information in the initial training databases never changes. To this, AI Agent 10 can be re-trained once in a while to keep the static information up to date.

In some embodiments, Database 12 is an initial training database storing policies. Policies comprise the service provider company's service cancellation policy, data retention privacy policy, and service promotion policy. Service provider may set up a service cancellation policy which was adopted when the customer signed up for the subscription service. Service providers may update their service cancellation policy which was later on adopted and agreed by a customer. In most scenarios, such updates are once per year or longer. Service provider updates data retention privacy policy in accordance with the development of regulatory requirements. Data retention privacy policy is used in initial training to help AI Agent 10 inform End User 1′ about what will happen to his/her data after the cancellation and offer options for data deletion when it is possible and applicable. Service providers may also set their subscription promotion policies, such as one year of subscription qualifies a customer to ten percent discount of future subscription. Service providers input the policy information into the policy database, which in turn, is used to train AI Agent 10.

In some embodiments, Database 12 is an initial training database storing cancellation workflow information. Cancellation workflow information comprise steps to complete a procedure of cancelling a subscription service. In some embodiments, the workflow is a standard procedure comprising receiving cancellation request from End User 1′, displaying multiple reasons of cancellation and potential options, informing the measure about how the end user's private data will be deleted or handled, and taking a cancellation action based on the choice made by End User 1′. In some other embodiments, the workflow is a customized procedure. Subject to End User 1′ response to the potential options, the workflow following up on that is customized. Take an instance, potential options End User 1′ has are cancelling the subscribed service all at once, downgrading to a lesser and cheaper service, taking up a promotion, or talking to a customer representative.

In some embodiments, Database 12 is an initial training database storing software tools or API information. The tool or API information can be of the Customer Retention System 1 which is used to create an online connection between the service provider and an end user. In some embodiments, such tool or API is a computer program programmed by a third-party merchant, service provider, or so. The purpose of the tool or API database is to multiply the capability of Customer Retention System 1 with capabilities of third-party functions. In accordance with most embodiments, the subscription service is configured to function in synergy with other software programs to provide comprehensive user experience.

Importantly, the third-party API or tool can be another AI program that functions independently from AI Agent 10 of Customer Retention System 1. AI Agent 10 is configured to consult, communicate with, and learn from another independent AI program if complexity is decided to be beyond scope. Any other suitable use cases and scenarios in accordance with aspects of the invention can be understood by one of skill in the same art.

Data stored in the dynamic training database are more frequently updated or visited. In some embodiments, these data are accessed, updated, removed, or added at dynamic training sessions. Dynamic training of AI Agent 10 is an ongoing process with the ability to continuously update and adapt AI Agent 10 based on new data or changing condition, without having to retrain the entire model or algorithms of AI Agent 10 from scratch. Dynamic training requires no or minimum manual intervention to fine tune model or algorithm to better suit for changing environment, data distributions, or user behaviors. Dynamic training happens in real-time or near-real-time when new data becomes available. Because of the flexibility of dynamic training, AI Agent 10 is enabled to adapt to individual users or specific scenarios, e.g., personalized real-time subscription cancellation, over time.

However, noted, the distinguish between initial training data and dynamic training data is arbitrary and determinable by a business. On occasions, all initial training data could be treated as dynamic. It is a balance of cost and practicability to decide between retraining and using dynamic knowledge.

In some embodiments, dynamic training database is locally located in an edge device. Data storage or memory of Terminal Device 11′ can be used as a dynamic training database. In some other embodiments, dynamic training database is remotely located at cloud, a data center, or a server.

In some embodiments, Database 12 is a service knowledge dynamic training database. Different from policy initial training database and workflow initial training database, dynamic service knowledge is information stored in a knowledge database and related to a specific service and which is dynamic and changeable over time. One good example of dynamic service knowledge is pricing information. Another example of dynamic service knowledge is technical and technological features of the subscription software. Details of available services by the subscription service provider are stored in the service knowledge dynamic training database. The frequency to update the service knowledge dynamic training database is much higher than once per year, although it may not be as high as real-time updating.

Moreover, as a distinction with initial training, the dynamic training of AI Agent 10 is continuous. AI Agent 10 is configured to continue receiving dynamic user information, service knowledge, and prompts from end users, and to continue building responses on top of previous responses it generates. The dynamic training process may happen at the same time when Customer Retention System 1 interacts with end users.

In some embodiments, Database 12 is a user-specific information dynamic training database. In general, user-specific information is the most dynamic information, and is used to update model or algorithm of AI Agent 10 in real-time or close to real-time timeframe. Dynamic training of AI Agent 10 is particularly useful and important in the rapidly changing context for AI Agent 10 to make recommendations or offer promotion that are best suited for the purpose of retaining customers and avoiding subscription cancellation.

A typical example of user-specific information is the subscription contract and details of an end user. It is needed for AI Agent 10 to understand if the terms of the subscription contract of End User 1′ requesting cancellation of service allow such cancellation, e.g., at a specific point of time, with a specific reason for cancellation, by a specific way of cancellation, etc.

Another typical example of user-specific information is the prior usage or interaction history of End User 1′ with the subscription service. The user-specific information dynamic training database is used to store the history of use and interaction along the tenure End User 1′ using the subscription service in a real-time manner. Moreover, the user-specific information in the database is used to train the model or algorithm of AI Agent 10 as the information comes. Such dynamic training is especially important because AI Agent 10 has the information handy when End User 1′ prompts to cancel the subscription. Understanding prior usage or interaction history enables AI Agent 10 to pinpoint one or more events or reasons why End User 1′ would want to cancel the subscription and make an informed offer of promotion or recommendation to retain the customer. Therefore, AI Agent 10 is enabled to provide personalized responses to address the issue at hand. For instance, several weeks before End User 1′ requesting cancellation of the subscription, End User 1′ encountered two consecutive disconnections to server to access the service during, and End User 1′ even complained about the second disconnection to a human representative previously. Hence, during the cancellation process, AI Agent 10 provides a promotion to upgrade the subscription service to a premier service with guaranteed minimum downtime with no extra charge to End User 1′. In this scenario, it is more likely End User 1′ to suspend the subscription cancellation and be turned into a longer-term customer.

User Interface 11 comprises API that is configured to allow users of a subscription service to interact with Customer Retention System 1. In some embodiments, User Interface 11 is a web-based program. In some other embodiments, User Interface 11 is a downloadable application program in an application marketplace of an Operating System (O/S) of a smart phone, a Virtual Reality or Augmented Reality (VR/AR) headset, etc. Therefore, User Interface 11 is configured to process text-based information, audio, video, or other similar forms of information.

User Interface 11 is configured to receive user prompts. User prompts can be received in multiple forms. In some embodiments, users input their questions, commands, or responses to the system by typing, writing, drawing on an input panel of User Interface 11, or by interacting with web or application component provided by service provider, e.g., button to cancel service. In some other embodiments, User Interface 11 is configured to receive users' audio input like voice command and similar. Users talk in their natural language(s) and User Interface 11 is configured to process audio signals and convert them to data to be further processed by Customer Retention System 1. In some other embodiments, User Interface 11 is configured to receive digital materials, such as images or video input users obtain from separate resources and feed these files to User Interface 11. In some other embodiments, User Interface 11 is further configured to scan users' body language, facial expressions, gestures or movements and convert them to data to be further processed by Customer Retention System 1. In some other embodiments, End User 1′ can use Terminal Device 11′ to scan a QR code or similar which leads End User 1′ to an interactive interface to engage with AI Agent 10. Other suitable ways to collect user input will be understood by one of skill in the same art.

User Interface 11 is further configured to deliver information and responses of Customer Retention System 1 to end users. Similar to prompt receiving functions, User Interface 11 can deliver information and responses to end users in multiple forms that human beings can appreciate and comprehend. In some other embodiments, User Interface 11 is configured to display text or picture response in an output panel. Users are allowed to browse the responses at their own pace, e.g., read, re-read, or pause the messages. In some other embodiments, User Interface 11 is configured to play audio or video-based response by an output device. Similarly, users are enabled to receive the audio or video-based response at the pace they wish or take similar actions on these responses. In yet some other embodiments, other ways to output responses may be tailor made to suit and serve users with special needs, e.g., users with hearing difficulties, illiterate or with reading difficulties, etc. Other suitable types of output device will be understood by one of skill in the same art.

Terminal Device 11′ provides a physical interface to enable interactions of users with Customer Retention System 1. The physical interface materializes the interactions users have with Customer Retention System 1 via User Interface 11 by input and output apparatus. In the embodiments when prompts from users are typed to User Interface 11, a physical or virtual keyboard is adopted as a part of Terminal Device 11′. In the embodiments when prompts from users are written or drawn to User Interface 11, a physical or virtual drawing pad is adopted as a part of Terminal Device 11′. In the embodiments when prompts from users are voice command, Terminal Device 11′ is equipped with a microphone or a sensor that shares the same function to convert audio signals to electric signals. In the embodiments when prompts from users are body language, facial expressions, gestures or movements, or a video clip or a photo about a defect product or tricky technical issue users encounter, Terminal Device 11′ is equipped with a camera or image sensor to capture visual signals and convert them to electric signals.

Similarly, Terminal Device 11′ is configured to provide responses and deliver information to end users in various modes or forms that human beings can appreciate and comprehend. In the embodiments when text or picture responses are output to end users. Terminal Device 11′ is installed with a physical or virtual display or screen. In the embodiments when audio or video-based responses are sent to end users, a speaker and/or a physical or virtual display or screen is used to convert electric signals to audible sound and/or visual information. In the embodiments when output responses are tailored to suit end users with special needs, special output devices can be adopted, such as bone conduction headset or similar.

In some embodiments, Terminal Device 11′ is a generic terminal device. Some examples of generic terminal devices include smartphones, tablets, personal computers, VR/AR headsets, smart cars, smart home appliances, etc. In some other embodiments, Terminal Device 11′ is a terminal device that is designed and made for special purposes. One good example of this category is tools used by the group of people with special needs.

The system architecture of FIG. 1 is meant to be exemplary and non-exclusive. One of skill in the art reasonably contemplate that other system configurations may be used in accordance with aspects of the present invention to improve customer retention rate with enhanced user experience.

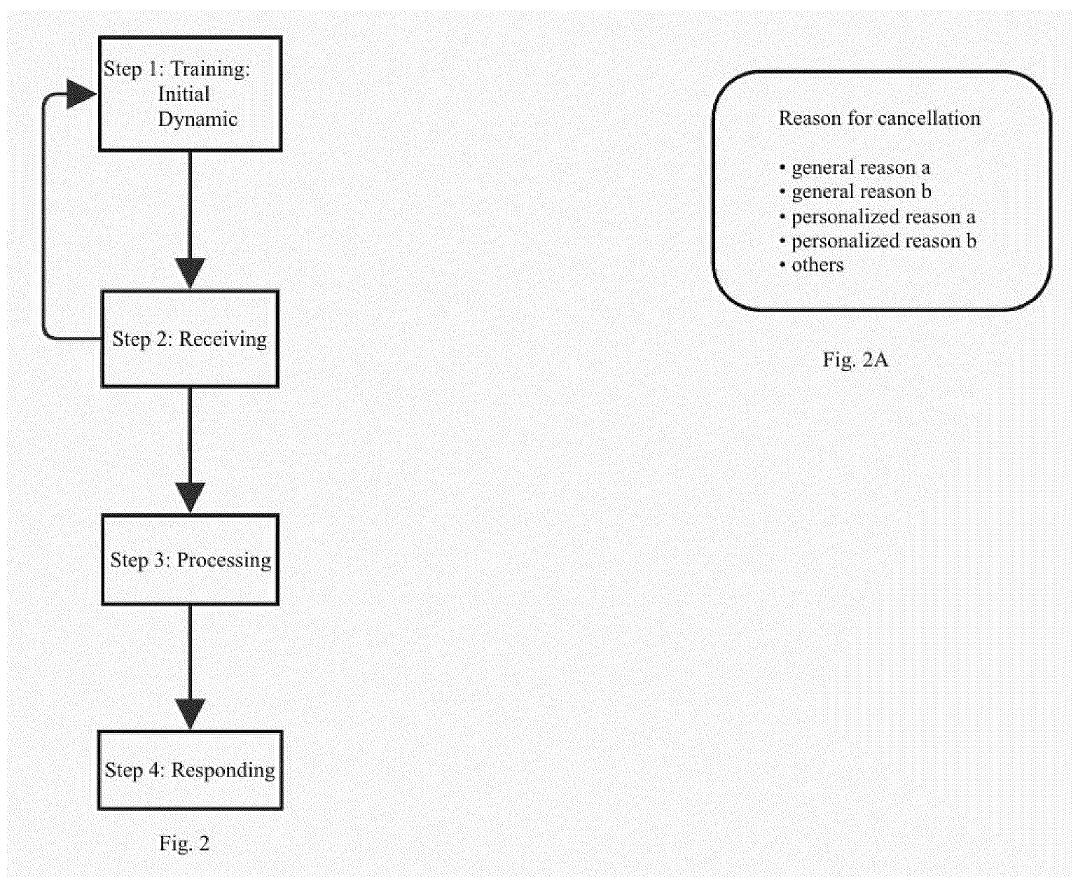

Reference now is made to FIG. 2. FIG. 2 is a workflow of using AI agent of the customer retention system to handle user's request to cancel subscription service, and take actions in accordance with aspects of the invention to improve customer retention rate with enhanced user experience. In any interaction session between End User 1′ and Customer Retention System 1, trained AI Agent 10 is configured to take multiple steps to process input received from end users and respond accordingly and take further actions to retain end user in a respectful, personalized, and efficient way.

At Step 1, AI Agent 10 of Customer Retention System 1 is trained, both initially and dynamically. AI Agent 10 is configured to connect electronically or magnetically with one or more initial and dynamic training databases to ensure access to various data needed to train AI Agent 10. AI Agent 10 is also configured to connect electronically or magnetically with User Interface 11 so that dynamic data collected by User Interface 11 when interacting with end users are properly feedback to AI Agent 10 for dynamic training purposes.

At the initial training session, data in policy database, workflow database, and API database are fed into the model or algorithm of AI Agent 10. Reliability and quality of the data is essential as the first step in teaching the model or algorithm to interpret data and make decisions. Mistakes or errors in the output of the model are adjusted to improve accuracy of responses. Similarly, dynamic training data like user-specific information and knowledge about the service provider's services are fed into the model or algorithm of AI Agent 10. Different from the initial training session, the dynamic training is constantly ongoing. Input and training happen in almost real-time. Such way, AI Agent 10 is equipped with most up-to-date information to handle cancellation requests from end users.

Comprehending natural languages and tones is another critical capability AI Agent 10 is configured to have. Powered by LLMs, AI Agent 10 is designed to understand, process, communicate, and interact in multiple natural ways human beings communicate. Also, tones of handling request of subscription cancellation are critical. In most scenarios, sympathetic and empathetic languages and tones are treated by end users as less aggressive and accommodating. Therefore, leading to better results of retaining quitting customers with promotions or different services from the service provider. Or, at least, languages and tones help obtain more genuine and useful feedback from customers about the reasons they are leaving, which in turn help future business in the long run. AI Agent 10 is configured to learn up cultural and delicacy of usage of language. Through the training of natural languages and tones associated thereof, the AI Agent 10 is configured to obtain societal cues during the interactions with end users, reduce dissatisfaction and frustration customers often feel when dealing with normal chatbots, and further enhance customer service experience.

At Step 2, AI Agent 10 receives user input from End User 1′ in relation to information about a subscription service. When End User 1′ engages AI Agent 10 after logging in, subscription information of End User 1′ is passed to AI Agent 10 from database as dynamic information to be used during the conversation. The information can make the conversation personalized and more targeting to solve issues of End User 1′. In some embodiments, the input of End User 1′ is not a prompt to cancel subscription service. However, AI Agent 10, equipped with dynamic information about subscription information of End User 1′ which is about to expire soon, is configured to engage with End User 1′ about renewal or similar. In some other embodiment, at a subscription cancellation backdrop, the user input AI Agent 10 receives can be a prompt to terminate the subscription service. In some embodiments, end users simply press a termination service button in the subscription section of their service accounts. In some other embodiments, end users can initial a conversation about service termination with virtual customer service representative, e.g., a chatbot on a web-based service, or a dialog interface in an application program. Regardless of the forms of user input, AI Agent 10 is training to identify the prompt to cancel service when it receives the request from End User 1′.

Further at Step 2, when AI Agent 10 receives user input from End User 11′ in relation to information about a subscription service, received information is registered and stored at the user-specific information database. Customer Retention System 1 is configured to treat information received from end users as dynamic training data for future fine tuning of the model or algorithm of AI Agent 10.

At Step 3, the prompt received from End User 1′ about his/her intention to cancel the subscription service is processed by AI Agent 10. With information from the assortment of databases, AI Agent 10 is configured to process End User 1′ request in the context of user-specific information and non-user-specific information. The goal of the processing is to understand End User 1′ instruction clearly, make judgment of the situation in hands, and generate a personalized interaction experience of cancellation.

Various possible situations where AI Agent 10 is trained and configured to handle are further described here. In one embodiment, when processing End User 1's prompt. AI Agent 10 is configured to cross reference service-specific information and user-specific information with policy data. Take an example, AI Agent 10 compares the user's subscription contract and its terms and conditions. Should the subscription contract have a term of service that End User 1′ was committed to and the term is not up yet, based on the service provider's cancellation and promotion policies, AI Agent 10 may decide the cancellation request is not a qualified one and generate a conversation stream to understand better the reasons End User 1′ wanting to cancel. Take another example, after receiving the cancellation request, AI Agent 10 identifies in End User 1′ usage history that he/she used twice a feature of the service that is out of the scope of the subscription. A reasonable response AI Agent 10 may generate is to recommend the feature to End User 1′ and make it a promotion to include the feature in subsequent subscription at no additional cost of End User 1′. Take another example, through engaging conversation with End User 1′, AI Agent 10 identifies one specific technical difficulty End User 1′ has when using the subscription service. A reasonable response AI Agent 10 may generate is to guide End User 1′ on how to use the function or to trouble shoot for the customer. This way, it is of a higher chance that the customer will be retained. Other suitable ways of interactions could be generated by AI Agent 10 and should be understood by one of skill in the same art.

At Step 4, the information generated to interact with End User 1′ is delivered via User Interface 11. In some embodiments, the delivery is a straight confirmation message of cancellation. In more likely scenarios, the delivery is interactive communication comprising personalized information dedicated to End User 1′. In some other embodiments, AI Agent 10 may escalate the cancellation procedure to a human customer service representative, if the situation allows or so arises, e.g., upon end users' requests. Regardless, Customer Retention System 1 is configured to conduct communication in an empathetic and sympathetic way.

With reference made to FIG. 2A now, this figure demonstrates an exemplary diagram of a communication the system output to an end user in accordance with aspects of the invention to improve customer retention rate with enhanced user experience.

Finding out the true reasons for cancellation of an existing customer is pivotal both for retaining the customer as possible and for further improving the subscription service for future businesses. User Interface 11 display top likely reasons for cancellation AI Agent 10 generated. Such a message comprises one or more general reasons which are applicable among most subscribers, and one or more personalized reasons which are related to past user experience such as customer support history, etc. Other suitable ways of communication could be generated by AI Agent 10 and should be understood by one of skill in the same art.

Although the invention is illustrated and described herein with reference to specific embodiments, the invention is not intended to be limited to the details shown. Rather, various modifications can be made in the details within the scope of equivalents of the claims by anyone skill in the art without departing from the invention.

What is claimed:

1. A system of customer retention, comprising:
a user interface, configured to interact with end user and communicate with an artificial intelligence agent;
an artificial intelligence agent, configured to communicate with end user via said user interface and to be connected with at least one database,
wherein said database storing end user specific information; and
said artificial intelligence agent, further configured to, when receiving a prompt from said user interface, generating a response based on said stored end user specific information.

2. The system of claim 1, further comprising a second database, configured to store policy information including cancellation policy and promotion policy information.

3. The system of claim 1, further comprising a second database, configured to store workflow information.

4. The system of claim 1, further comprising a second database, configured to store application programming interface information.

5. The system of claim 1, further comprising a second database, configured to store service specific information.

6. The system of claim 1, wherein said user specific information comprises user's subscription information.

7. The system of claim 1, wherein said user specific information comprises user's prior usage of a subscribed service.

8. A method for retaining end user of a service, comprising:
collecting end user specific information by an artificial intelligence agent;
training said artificial intelligence agent with said end user specific information;
receiving a prompt from said end user to terminate subscription of a service; generating response by said artificial intelligence agent to said prompt,
wherein said response is at least partially correlated to said end user specific information; and
delivering said response via said user interface to said end user.

9. The method of claim 8, further comprising:
training said artificial intelligence agent with policy information including cancellation policy and promotion policy information.

10. The method of claim 8, further comprising:
training said artificial intelligence agent with workflow information.

11. The method of claim 8, further comprising:
training said artificial intelligence agent with application programming interface information.

12. The method of claim 8, further comprising:
training said artificial intelligence agent with service specific information.

13. The method of claim 8, wherein said user specific information comprises user's subscription information.

14. The method of claim 8, wherein said user specific information comprises user's prior usage of a subscribed service.

15. A non-transitory computer readable medium including a set of instructions that are executable by one or more processors of a computer to cause the computer to perform a method for retaining end user of a service, the method comprising:
collecting end user specific information by an artificial intelligence agent via a user interface; training
said artificial intelligence agent with said end user specific information;
receiving a prompt from said end user to terminate subscription of a service; generating
response by said artificial intelligence agent to said prompt,
wherein said response is at least partially correlated to said end user specific information; and
delivering said response via said user interface to said end user.

16. The method of claim 15, further comprising:
training said artificial intelligence agent with policy information including regulatory compliance information.

17. The method of claim 15, further comprising:
training said artificial intelligence agent with workflow information.

18. The method of claim 15, further comprising:
training said artificial intelligence agent with application programming interface information of a third-party software.

19. The method of claim 15, further comprising:
training said artificial intelligence agent with service specific information.

20. The method of claim 15, wherein said user specific information comprises user's subscription information.

21. The method of claim 15, wherein said user specific information comprises user's prior usage of a subscribed service.
